(19) United States
(12) Patent Application Publication
(10) Pub. No.: US 2012/0164493 A1
(43) Pub. Date: Jun. 28, 2012

(54) ELECTROCHEMICAL CELL HAVING LITHIUM TITANATE

(75) Inventors: Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/265,243

(22) PCT Filed: Mar. 29, 2010
(86) PCT No.: PCT/EP2010/001986

§ 371 Date: Mar. 13, 2012

(30) Foreign Application Priority Data
Apr. 24, 2009 (DE) 10 2009 018 804.5

(51) Int. Cl. H01M 4/131; H01M 10/056; H01M 10/44; H01M 10/0525

(52) U.S. Cl. 429/50; 429/231.1; 429/223; 429/224; 429/188

(57) ABSTRACT

The invention relates to an electrochemical cell, comprising a negative electrode comprising a lithium titanate; a positive electrode; and a separator separating the negative from the positive electrode. The cell can be preferably used for driving a vehicle having an electric motor, preferably having a hybrid drive system.

Priority application DE 10 2009 018 804.5 is fully incorporated by reference into the present application.

The present invention relates to an electrochemical cell, the negative electrode whereof comprises a lithium titanate. The cell can preferably be used for driving a vehicle with an electric motor, preferably with a hybrid drive system.

Electrochemical cells used for driving a vehicle with an electric motor or with a hybrid drive system are already known. Commercially available types comprise, for example, a positive electrode based on lithium mixed oxides such as lithium cobalt oxide, lithium manganese oxide or lithium iron phosphate, and a negative electrode based on carbon. If a plurality of cells are suitably connected in series and/or in parallel in the form of a storage battery, their capacity can be high enough to drive, for example, a vehicle with a hybrid drive system.

Commercially available electrochemical cells are also known, wherein the negative electrode comprises a lithium-containing material, for example lithium titanate. Lithium manganate is then preferably used as the positive electrode. Such cells possess a high inherent reliability, which is particularly important when they are used to drive an electric motor in a vehicle. They tend not to produce smoke or fire or even explosion in the presence of short-circuit, exhaustive discharge, overloading or mechanical destruction. Moreover, they exhibit a high rapid-charging capacity, a sufficient capacity even after high discharge/charge cycles, and are still effective over a wide temperature range. Typical characteristic data for a cell stated by manufacturers show a working voltage from 2 V to 2.5 V over a temperature working range from −50° C. to 75° C. The capacity of such cells after 2000 charging cycles can be over 90% of the original capacity.

A high level of endurance of the cells with as small a capacity drop as possible is important in the case of vehicles with a hybrid drive system, because the cells in the hybrid drive system are subjected to constant charging and discharging.

The problem of the present invention was to make available an electrochemical cell which exhibits a sufficient capacity even after a high number of charge/discharge cycles.

The problem was able to be solved with an electrochemical cell, comprising

a negative electrode comprising a lithium titanate;
a positive electrode; and
a separator which separates the negative from the positive electrode.

The term “negative electrode” signifies the electrode which gives off electrons when connected to the consumer, i.e. for example an electric motor. The negative electrode is accordingly the anode.

The term “positive electrode” signifies the electrode which takes up electrons when connected to the consumer, i.e. for example an electric motor. The positive electrode is accordingly the cathode.

If the cell is charged, the negative electrode becomes the cathode and the positive electrode becomes the anode.

The lithium titanate used for the negative electrode preferably has a spinel structure and has the chemical composition Li₄Ti₅O₁₂.

Methods for producing this spinel or such spinel structures are known from the prior art, for example from US 2004/0197657.

In the lithium titanate spinel, lithium/titanate ratios may also be set which diverge from the ratio in Li₄Ti₅O₁₂. Such spinel structures are disclosed in US 2008/0226987.

The use of a lithium titanate with a spinel structure also improves the rapid-charging capacity of the electrochemical cell.

In a preferred embodiment, the negative electrode contains carbon, apart from lithium titanate. The conductivity of the electrode can thus be further increased.

The carbon can be present as a coating on the electrode, preferably as a carbon layer with a thickness of a few microns.

If the carbon coating has a diamond-like structure, it is also referred to as a “hard carbon coating”. Such a layer offers an effective protection against external influences, such as for example mechanical or chemical influences.

The coating with carbon can however also be produced with a non-woven fabric of carbon fibres. Such carbon is often also referred to as “soft carbon”.

The carbon can also be present on the negative electrode in amorphous form.

The terms “hard carbon”, “soft carbon” and “amorphous carbon” are known to the person skilled in the art, as are methods for producing such carbon modifications and their use in the production of electrodes. Further and likewise known embodiments are carbon in the form of “nanocarbon tubes”, “nano buds” or “foam”.

In an embodiment of the electrochemical cell of the present invention, the positive electrode contains a mixed oxide that is different from lithium titanate.

The mixed oxide preferably contains one or more elements selected from nickel, manganese and cobalt.

The mixed oxide containing nickel, cobalt and manganese is preferably present in the mixture with lithium manganate. The lithium manganate preferably has the formula LiMn₂O₄.

Such electrode material is known from the prior art. These oxides used for the positive electrode are commercially available or can be produced according to known methods.

It is also preferable for the negative electrode or the positive electrode or the negative electrode and the positive electrode to comprise an electrode carrier. The oxides listed above are deposited on the electrode carrier. The deposition can take place on one side or on both sides, preferably in the form of coatings.

In one embodiment, the electrode carrier comprises a foil of copper or a foil of an alloy with copper. In another embodiment, the electrode carrier comprises a foil of aluminium.

The electrode carrier can also be present in the form of a net or fabric. Nets or fabrics of metal are preferably suitable, preferably of aluminium or copper or a copper alloy, or nets and fabrics of plastics.

In a preferred embodiment, the electrode carrier of both the positive and the negative electrode comprises aluminium, preferably a foil of aluminium.

In a particularly preferred embodiment, at least one of the electrodes, preferably both electrodes, contains no carrier foil. At least one of the electrodes, preferably both electrodes, then preferably contains aluminium chips or copper chips or chips of a copper alloy in order to increase the conductivity.

An embodiment of the electrodes is also possible, wherein the carrier foil is replaced by conductivity additives such as graphite or electrically conductive plastics, such as polyparaphenylene, polythiophene, polypyrrole, poly(paraphenylene-vinylene), polyaniline.

In order to improve the adhesion of the oxides on the electrode carrier, the oxides preferably contain a suitable binding agent. It is preferable for the binding agent to comprise a fluorinated polymer, preferably a polyvinylidene fluoride. Suitable products can be obtained for example under the trade names Kynar® or Dyneon®.

The electrodes accordingly comprise polyvinylidene fluoride in a preferred embodiment.

In order to produce the electrodes, the oxides can for example be mixed into a paste with the binding agent and the obtained paste can be applied on the electrode carrier. Suitable methods are known in the prior art.

In order that an uncontrolled lithium-ion transfer between the two electrodes does not occur, the latter are separated from one another by a separator. The separator must however enable the necessary lithium-ion transport through the separator.

The separator preferably comprises a non-woven fabric of electrically non-conductive fibres, wherein the non-woven fabric is coated on at least one side with an inorganic material. EP 1 017 476 describes such a separator and a method for its production.

The separator is preferably coated with an ion-conducting inorganic material.

As a separator which separates the positive electrode from the negative electrode, use is preferably made of a separator which preferably comprises an at least partially substance-permeable carrier which is not electron-conducting or is only poorly so, wherein the carrier is coated on at least one side with an inorganic material, wherein, as an at least partially substance-permeable carrier, use is preferably made of an organic material which is preferably constituted as a non-woven fabric, wherein the organic material preferably comprises a polymer and particularly preferably a polyethyleneglycol terephthalate (PET), a polyolefin (PO) or a polyetherimide (PEI), wherein the organic material is coated with an inorganic ion-conducting material, which is ion-conducting preferably in a temperature range from −40° C. to 200° C., wherein the inorganic, ion-conducting material preferably comprises at least one compound from the group of oxides, phosphates, sulphates, titanates, silicates, aluminosilicates of at least one of the elements zirconium, aluminium, lithium, in particular zirconium oxide, and wherein the inorganic material preferably comprises particles with a maximum diameter less than 100 nm.

Suitable polyolefins are preferably polyethylene, polypropylene or polymethylpentene. Polypropylene is particularly preferred.

The use of polyamides, polyacrylonitriles, polycarbonates, polysulphones, polyether sulphones, polyvinylidene fluorides, polystyrenes as organic carrier material is also conceivable.

Mixtures of the polymers can also be used.

A separator with PET as a carrier material is commercially available under the name Separion®. It can be produced by methods such as are disclosed in EP 1 017 476.

The term “non-woven fabric” signifies that the polymers are present in the form of fibres in non-woven form (non-woven fabric). Such non-woven fabrics are known from the prior art and/or can be produced according to known methods, for example by a spin-bonded process or a melt-blowing process, such as referred to for example in DE 195 01 271 A1.

In a further embodiment, the separator comprises a polyethyleneglycol terephthalate, a polyolefin, a polyetherimide, a polyamide, a polyacrylonitrile, a polycarbonate, a polysulphone, a polyether sulphone, a polyvinylidene fluoride, a polystyrene, or mixtures thereof.

The separator preferably comprises a polyolefin or a mixture of polyolefins.

A separator, which comprises a mixture of polyethylene and polypropylene, is then particularly preferred in this embodiment.

Such separators preferably have a layer thickness from 3 to 14 μm.

The polymers are preferably present in the form of fibrous non-woven fabrics.

The term “mixture” or “mix” of polymers signifies that the polymers are preferably present in the form of their non-woven fabrics, which are connected to one another in layers. Such non-woven fabrics or non-woven fabric composites are disclosed for example in EP 1 852 926.

In a further embodiment of the separator, the latter is made from an inorganic material.

As an inorganic material, use is preferably made of oxides of magnesium, calcium, aluminium, silicon and titanium, as well silicates, zeolites, borates and phosphates. Such materials for separators and methods for producing the separators are disclosed in EP 1 783 852.

In a preferred embodiment of this embodiment of a separator, the separator is made from magnesium oxide.

In a further embodiment, 50 to 80 wt. % of the magnesium oxide can be replaced by calcium oxide, barium oxide, barium carbonate, lithium phosphate, sodium phosphate, potassium phosphate, magnesium phosphate, calcium phosphate, barium phosphate or by lithium borate, sodium borate, potassium borate, or mixtures of these compounds.

The separators of this embodiment preferably have a layer thickness of 4 to 25 μm.

In a particularly preferred embodiment of the electrochemical cell according to the invention, the separator is applied to at least one of the electrodes.

Methods for applying the separator on an electrode are known from the prior art. The application can preferably take place by gluing on or by combined extrusion of electrode material with separator material.

In a further particularly preferred embodiment, the positive or the negative electrode or the positive and a negative electrode are applied directly on the separator.

The capacity of the separator for ionic conduction can be further improved if a non-aqueous electrolyte is added to the latter, i.e. if it is saturated with this electrolyte. The non-aqueous electrolyte preferably comprises an organic solvent and lithium ions.

The organic solvent is preferably selected from ethylene carbonate, propylene carbonate, diethylcarbonate, dipropylcarbonate, 1,2-dimethoxyethane, γ-butyrolactone, tetrahydrofurane, 2-methyltetrahydrofurane, 1,3-dioxolane, sulpholane, acetonitrile, or phosphoric ester, or mixtures of these solvents.

The lithium ions present in the electrolyte preferably comprise one or more counter-ions, selected from AsF₆⁻, PF₆⁻, PF₃(C₂F₅)₃⁻, PF₃(CF₃)₃⁻, BF₄⁻, BF₂(CF₃)₂⁻, BF₃(CF₃)₃⁻, [B(COOCOO)₂], CF₃SO₃⁻, C₄F₉SO₃⁻, [(CF₃SO₂)₂N]⁻, [(C₂F₅SO₂)₂N]⁻, [(CN)₂N]⁻, ClO₄⁻.

In a further preferred embodiment, the electrodes are present in the form of an electrode stack, which comprises at least one separator, preferably the separator described above. The production of a stack comprising fixed separators alternately stacked one above the other and electrodes for an electrochemical cell is known for example from DE 10 2005 042 916 A1.

The stack can also be present in the form of a coil, such as is known for example from EP 0 949 699.

The electrochemical cell further comprises at least one current conductor, which is connected to the electrodes or the electrode stack.

The electrochemical cell can be connected via this current conductor for example to an electric motor, in order to supply the latter with electric current.

An embodiment of the electrochemical cell with at least 2 electrochemical cells according to the invention can also be referred to as a storage battery.

The electrodes which are separated by the separator and the electrode stack are located in a housing which is suitable for the battery or storage battery operation, for example in an aluminium housing.

A further subject-matter of the invention is also the use of the electrochemical cell according to the invention for supplying an electric motor with electric current.

The electrochemical cell is preferably used in a vehicle with a hybrid drive system.

The electrochemical cell as well as the electrodes used in it can be produced by methods which are known. Such methods are described for example in “Handbook of Batteries, Third Edition, McGraw-Hill, Editors: D. Linden, T. B. Reddy, 35.7.1”.

The electrochemical cell of the present invention can also be produced according to a method, wherein the separator is applied directly onto at least one of the electrodes, i.e. onto the negative electrode and/or the positive electrode.

A laminated composite then arises through coextrusion. Such methods are disclosed for example in EP 1 783 852.

Accordingly, the present invention also relates to a method for producing the electrochemical cell according to the invention, characterised in that the separator is applied onto at least one electrode and the formed composite is coextruded.

In a preferred embodiment, the separator, which preferably contains the inorganic material in the form of a paste or dispersion, is coextruded with at least one electrode.

A laminated composite comprising an electrode and the separator or a laminated composite comprising the two electrodes and the separator lying in between thus arises.

Accordingly, the present invention also relates to a method for producing the electrochemical cell according to the invention, characterised in that the coextrusion is a paste extrusion.

After the extrusion, the formed composite can be dried or sintered using the usual methods.

It is however also possible to produce the negative electrode and the positive electrode and the separator separately from one another and to produce the educt mixtures, from which the negative and the positive electrode and the separator are prepared, separately from one another.

The electrodes produced separately from one another and the separator or their educt mixtures for the production are then fed continuously and separately to a processor unit, wherein the negative electrode with the separator and the positive electrode are laminated to form a cell composite.

The processor unit preferably comprises or consists of laminating rollers.

Accordingly, the invention also relates to a method for producing the electrochemical cell according to the invention, characterised in that the separator and the negative and the positive electrode are fed separately from one another to a processing unit and laminated together there.

Such a method is known from WO 01/82403.

### EXAMPLES

An electrochemical cell was constructed, the positive electrode whereof contained nickel/cobalt/manganese mixed oxide and lithium manganese oxide. The negative electrode contained lithium titanate with carbon as a conductive additive. Separion® was used as a separator. The electrodes were applied directly onto the separator.

Charging and discharging was carried out as follows (CC charging and discharging current; CV charging and discharging voltage; C charging and discharging current expressed in amperes as a multiple of the capacity):
At 25° C.:
Charging: CC/CV 1C(4 A)/2.7 V
Discharging: CC/CV 10C/2.55 V; deliverable capacity 4.25 Ah
   CC/CV 20C/2.4 V; deliverable capacity 4.0 Ah

The capacity load amounted to approx. 70% at a temperature of −30° C.

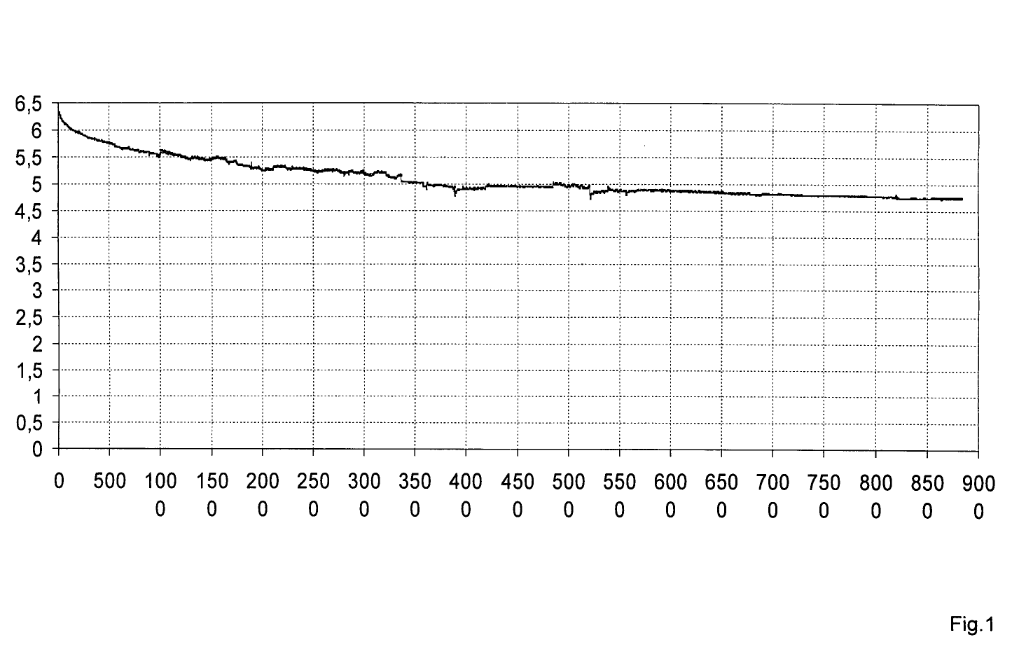

FIG. 1 shows the capacity of the electrochemical cell as a function of the number of charge/discharge cycles. The capacity stood at 6.5 Ah at the start of the measurement. The charging and also the discharging current amounted to 19.5 A (3C). The measurement was carried out up to a cycle count of approx. 9000. The capacity reached at the end of the cycle was over 4.5 Ah.

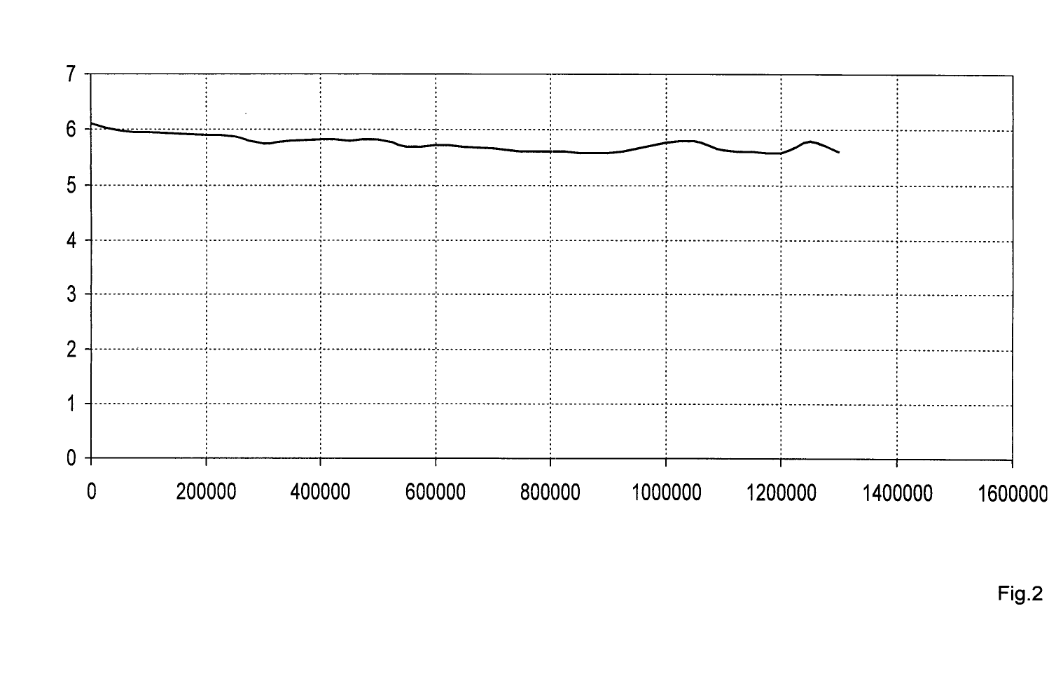

FIG. 2 shows the capacity as a function of the number of charging/discharging pulses. The pulse duration for the discharge amounted to 8 s with a discharge current of 56 A (8.55C), the pulse duration for the charging amounting to 3 with a charging current of approx. 146 A (22.7C). More than 1,000,000 pulses were able to be reached.

1.-15. (canceled)

16. An electrochemical cell, comprising
a negative electrode comprising a lithium titanate;
a positive electrode;
a separator which separates the negative from the positive electrode, wherein the separator comprises an at least partially substance-permeable carrier which is not electron-conducting or is only poorly electron-conducting so, wherein the carrier is coated on at least one side with an inorganic material, and wherein, as an at least partially substance-permeable carrier, use is made of an organic material which is constituted as a non-woven fabric.

17. The electrochemical cell according to claim 16, wherein the organic material preferably comprises a polymer and particularly preferably a polyethyleneglycol terephthalate (PET), a polyolefin (PO) or a polyetherimide (PEI), wherein the organic material is coated with an inorganic ion-conducting material, which is ion-conducting preferably in a temperature range from −40° C. to 200° C., wherein the inorganic, ion-conducting material comprises at least one compound from the group of oxides, phosphates, sulphates, titanates, silicates, aluminosilicates of at least one of the elements zirconium, aluminium, lithium, and wherein the inorganic material preferably comprises particles with a maximum diameter less than 100 nm.

18. The electrochemical cell according to claim 17, wherein the negative electrode additionally contains carbon.

19. The electrochemical cell according to claim 18, wherein the positive electrode contains a mixed oxide which is different from lithium titanate.

20. The electrochemical cell according to claim 19, wherein the mixed oxide contains one or more elements selected from nickel, manganese, cobalt.

21. The electrochemical cell according to claim 19, wherein the mixed oxide contains nickel, manganese and cobalt and lithium manganate.

22. The electrochemical cell according to claim 21, wherein the electrodes comprise an electrode carrier, on which either lithium titanate or mixed oxide is deposited on one side or both sides.

23. The electrochemical cell according to claim 22, wherein the electrode carrier is made of aluminium.

24. The electrochemical cell according to claim 1, wherein at least one of the two electrodes does not comprise an electrode carrier.

25. The electrochemical cell according to claim 23, wherein the at least one electrode comprises additives of aluminium or copper chips, graphite or conductive plastics.

26. The electrochemical cell according to claim 25, wherein the separator is applied on at least one of the electrodes.

27. The electrochemical cell according to claim 26, wherein the separator comprises a non-aqueous electrolyte containing an organic solvent and lithium ions.

28. The electrochemical cell according to claim 28, wherein the electrodes are present in the form of an electrode stack, which comprises at least one separator according to claim 10.

29. A method comprising supplying an electric motor with electric current comprising incorporating an electrochemical cell according to claim 1.

30. The method according to claim 29, wherein the electric motor is in a vehicle with a hybrid drive system.
